(19) United States
(12) Patent Application Publication
(10) Pub. No.: US 2009/0294243 A1
(43) Pub. Date: Dec. 3, 2009

(54) Currency Validator Video Graphic Display Bezel

(76) Inventors: Harold Charych, Poquott, NY (US); Thomas W. Mazowiesky, Patchogue, NY (US); Miroslaw Blaszczec, Lindenhurst, NY (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/130,375

(22) Filed: May 30, 2008

(51) Int. Cl. G07F 7/04; G09G 3/20

(52) U.S. Cl. 194/206; 345/55

(57) ABSTRACT

A bezel display for a currency acceptor that displays a pixelated image of the last bill accepted by the validator to show the player what was inserted. When not displaying the last bill accepted, the display can be used as an aesthetic addition, and when a fault occurs in the acceptor, it can display in multiple languages what is causing the fault, as well as display images showing where the fault has occurred.

### TECHNICAL FIELD

The present invention relates to the field of currency validators and more specifically to the system of currency validator having a video graphic display bezel, for displaying data that may be important to the operator/user of the machine.

### BACKGROUND

Currency validators are devices that help automate the sales of goods and services all over the world. These devices started out as simple magnetic sensing units in the US, capable of detecting the magnetic signature of notes supplied by the US Treasury. As technology advanced, these simple devices were updated to include optical sensing, initially with one light frequency and then developing into units capable of detecting multiple spectra, from near infrared to ultraviolet light.

The original units accepted only one or two denominations, but today's machines can handle many denominations and cross international boundaries as well. Global Payment Technologies manufactures currency validators that can accept 64 different denominations from as many countries in a single unit, including the storage box (stacker) for holding accepted notes.

One drawback to multi-denomination acceptance is that occasionally a user will, for example, insert a $1 note, but think he has inserted a different note (say a $10 or $20 note). When the machine credits him with $1, he stops play and then calls for assistance. In order to resolve the dispute, the casino must dispatch technical and accounting personnel to the game. The machine must be opened and one of several things occurs. With most validators, the stacker must be unlocked and removed from the game, the stacker is taken to a secure location, and then opened and examined to resolve the dispute. U.S. Pat. No. 6,585,260 from Japan Cash Machine, describes an improvement to stacker technology, by adding a window to the stacker door, and allowing the mechanism to be displaced to allow the last stacked bill to be viewed without opening the stacker. With a stacker of this type, the stacker does not need to be removed to a secure location, or opened to determine the last insertion. In U.S. Pat. No. 6,712,352 from Mars, a further improvement is disclosed, describing a stacker that contains a window and transparent mechanism parts of the stacker. This permits the operator to view the last note stacked without needing to move the mechanism in the stacker, or to open the stacker to ascertain its contents.

Once the disputed note is resolved, the stacker is replaced in the game and the game play is resumed. This resolution dispute process is disruptive to game play in a casino, and further requires casino personnel to be available at all times to resolve disputes. Further, while the game is open, play cannot resume, leading to possible revenue loss to the casino.

Among other things, the invention allows disputes between what denomination of a banknote the player thought he or she inserted and what actually was inserted to be resolved without requiring the stacker to be removed from the game. The invention provides a robust means of attracting a player's attention to a game by utilizing a graphic bezel display on the currency validator entrance. The invention utilizes the graphic bezel as a diagnostic tool, to assist the technician in troubleshooting a unit that is not working properly, without using preset alpha, numeric, or alpha numeric codes. High resolution scanning technology developed by Global Payment Technology is described, for example, in U.S. patent application Ser. No. 11/473,368, which disclosure is fully incorporated herein by reference. This technology has been incorporated into the present invention. This technology allows sub-millimeter scans to be taken, and currency validators incorporating this high resolution scanning technology can capture data that permit a high resolution picture of a banknote, allowing new and improved applications such as displaying a banknote picture on the graphic bezel of the present invention.

### SUMMARY OF THE INVENTION

The present disclosure provides a currency validator video graphic display bezel that displays a pixelated image of the last bill accepted by the currency validator. This can help resolve disputes between the player and the casino when the player thinks the amount of money he inserted is different than what was credited to him. The video graphic display bezel can also be an aesthetic addition, attracting players to the particular game. It can also help display error messages when one arises.

In one aspect of the present disclosure, a currency validator is comprised of a bill acceptor having a validator for determining the authenticity of a bill inserted into the acceptor, a bezel assembly adjacent to an opening of the bill acceptor, and a graphic display unit mated to the bezel assembly.

A second aspect of the present disclosure includes a currency validator comprising a bill acceptor having a validator for determining the authenticity of a bill inserted into the acceptor, a bezel assembly adjacent to an opening of the bill acceptor, a graphic display unit mated to the bezel assembly, and a diagnostic display panel.

Some of the objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate at least one embodiment of the invention and together with the description, serve to explain the principles of the invention.

FIG. 1 is a side view of a high resolution scanning system of a currency validator, according to an exemplary disclosed embodiment.

FIG. 2 is a schematic diagram of a linear array and a processing module, according to an exemplary disclosed embodiment.

FIG. 3 is a schematic diagram of the components of a video graphic display bezel, according to an exemplary disclosed embodiment.

### DETAILED DESCRIPTION OF THE DRAWINGS

Reference will now be made in detail to the exemplary embodiments of the invention, examples of which are illustrated in the accompanying drawings. Wherever possible, the same reference numbers will be used throughout the drawings to refer to the same or like parts.

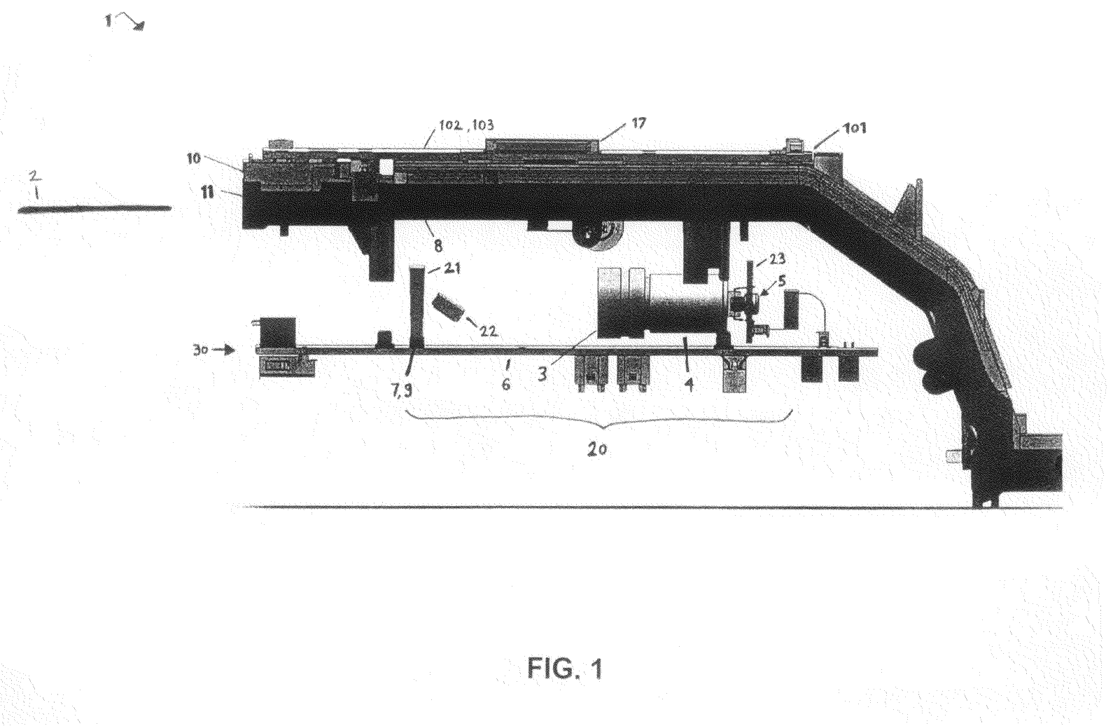

FIG. 1 illustrates a side view of a high resolution scanning system of a currency validator, according to an exemplary disclosed embodiment. As shown in FIG. 1, the currency validator 1 comprises several components, including one or more of a note transporter module 10, a data collection module 20, and a processing module 30.

Note transporter module 10 may be any suitable note transporter known in the art. Note transporter module 10 may be configured to transport note 2 through note channel 11 in any suitable direction using any suitable means, for example, by rollers or belts. The rollers or belts may be actuated via an attached motor (not shown). Note channel 11 may be at least as big in dimension (length, width, and height) as the largest currency note in circulation; however, note channel 11 may have any suitable dimensions in the length, width, and height directions. Note transporter module 10 may be constructed of an opaque material such as black ABS plastic. However, note transporter module 10 may be constructed of other suitable materials including, but not limited to, plastic, glass, or metal which may be opaque or transparent. Note transporter module 10 may include transmission window 8, which may be disposed between note 2, and lens 3 and/or linear array 5. Note 2 may be transported through note transporter module 10 at a rate such that a specific number of lines of note 2 may be scanned (e.g., one line for each wavelength may be scanned every 0.6 mm of note 2). The rate may be incremental or substantially continuous.

A data collection module 20 may comprise multiple components. In one embodiment, a data collection module 20 includes a printed circuit board 6 on which various components may be attached. The printed circuit board 6 may be mounted substantially parallel with a bottom surface of note transporter module 10 and/or a plane including note 2 as it travels through note channel 11, however, any suitable configuration that allows scanning of note 2 will suffice. Printed circuit board 6 may include any number of components necessary to scan and process a note 2, for example, light pipe 21, fold mirror 22, and LEDs 7, 9.

Lens 3 may be mounted to lens mount 4, which may in turn itself be mounted to printed circuit board 23. A linear array 5 may be configured on the printed circuit board 23. Lens 3 may be mounted such that an entire width of note channel 11 is viewable by linear array 5, for example, via transmission window 8. The distances between lens 3, linear array 5, and note 2 may be jointly or independently set and controlled by any suitable mechanism and/or method. Lens 3 may be configured such that an entire width of note channel 11 is focused on linear array 5, even if linear array 5 has a width that is less than a width of note channel 11.

Linear array 5 may be any suitable note scanning array. The linear array 5 is a row of sensors configured to take a simultaneous scan of a line of an object, e.g., an entire width of a note 2. This is in contrast to individual photo detectors used in conventional currency validators, which are only configured to scan and collect data relative to one point of note 2. Even a plurality of individual photo detectors can only scan a plurality of points, and not an entire line of data.

An example of a linear array 5 that may be used includes a TSL1401R, 128×1 array manufactured by TAOS INC. The TSL1401R is well adapted for use in note scanning. Some generally desirable features of a linear array 5 which the TSL1301R possesses includes a good response to a wide frequency range (e.g., between about 350 and about 980 nm), a wide dynamic range (e.g., about 72 dB), a linear response across the array (e.g., <4%), a pixel readout frequency of about 8 MHz, and a sufficient number of pixels across the array (e.g., 128) to give sub-millimeter resolution without generating excessive data. Each pixel on the array may be specified to be within about ±7.5% of the average of all pixels in the array, over temperature. Linear array 5 may be configured to scan a note 2 having a width of about 8 mm (i.e., about a width of linear array 5 itself) up to at least a note 2 having a width of about 90 mm (i.e., suitably width enough to accommodate substantially all paper currencies). Each pixel may scan a line of note 2 having a width in a direction of travel of note 2 of about 0.67 mm. Accordingly, linear array 5 may scan a line of note 2 about every 0.6 mm per wavelength. The device is physically small, inexpensive and is well adapted to use with commercially available lenses, thereby reducing overall costs for use in a note validator. The device can be used over a wide voltage range, making it suitable for use, for example, with both 5 volt and 3.3 volt based systems.

The currency validator 1 and/or data collection module 20 may include one or more illuminators or sets of illuminators such as LEDs 7, 9 used to illuminate transmission window 8. One set of LEDs 7 may be configured to emit light having a frequency different from a second set of LEDs 9. LEDs 7, 9 may also or alternatively be connected and controlled such that only one set of LEDs which emit light at one frequency may be illuminated at any point in time. As an example, LEDs 7 may be 660 nm red LEDs, and LEDs 9 may be 880 nm infrared LEDs. At any one time, LEDs 7 and/or LEDs 9 may be illuminated. Additional colors can be added and/or selected by adding more LEDs and/or control signals, for example, blue (470 nm) or green (565 nm). However, LEDs 7, 9 may emit any color, for example, red, infrared, ultraviolet, or any other wavelength in the visible or non-visible spectrum.

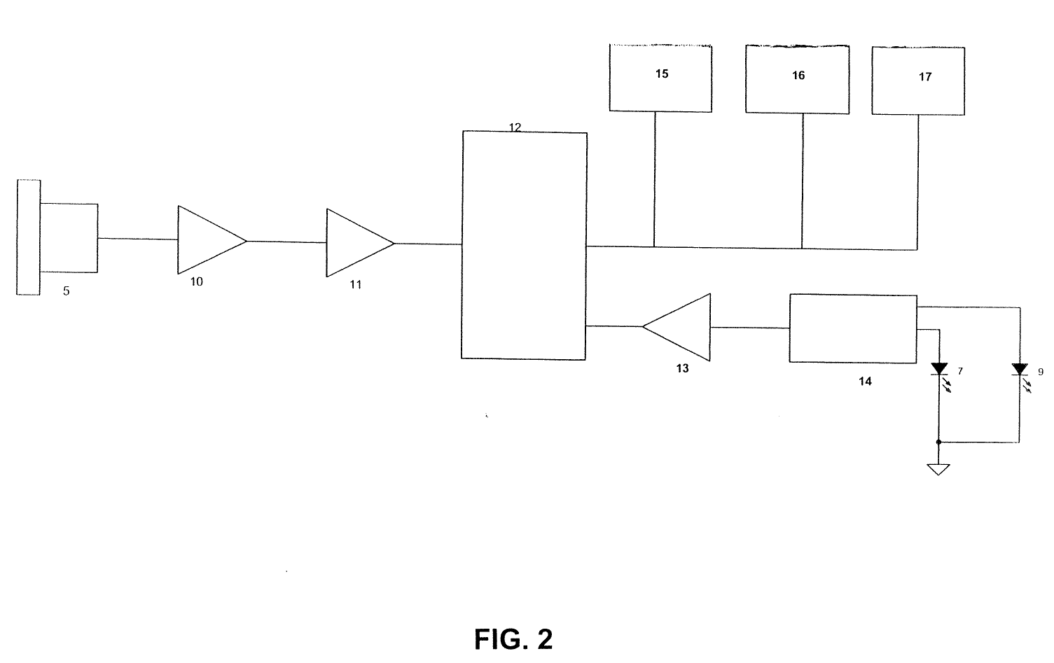

FIG. 2 illustrates the linear array 5 and the various components of the processing module 30. The processing module 30 may include a printed circuit board 6 and one or more of amplifier 10, (Analog-to-digital) A/D converter 11, CPU 12, (Digital-to-analog) D/A converter 13, and LED driver circuitry 14. Processing module 30 may control components of the data collection module 20: including, one or more of LEDs 7, 9, linear array 5, and lens 3.

A combination of CPU 12, D/A converter 13, and LED driver 14 may control LEDs 7, 9. For example, CPU 12 may be used to set the intensity and/or duration of light output from LEDs 7, 9. A digital signal indicating such may thus be sent from CPU 12 to D/A converter 13, which may convert the digital signal into an analog signal, and then that signal may be sent to LED driver 14, which in turn will control the intensity and duration of light out from LEDs 7, 9 at the predetermined levels. In another example, CPU 12 may be used to determine which set of LEDs 7, 9 are illuminated. CPU 12 may send a signal COLOR to LED driver 14 indicating that only one color set of LEDs 7, 9 are to be illuminated at a given time. LED driver 14 will thus illuminate the proper set of LEDs 7, 9. Choosing which set of LEDs 7, 9 to illuminate may be a function of several factors, for example, the color and composition of note 2 being scanned. In operation, as note 2 moves through note channel 11, LEDs 7, 9 may be illuminated on alternate exposure cycles by LED driver 14, which may result in a multi-color scan of note 2. For example, for a two color scan of note 2, a line of note 2 will be read about every 0.3 mm, alternating wavelengths of LEDs 7, 9, resulting in one scan for each wavelength every 0.6 mm. Additional colors can be added and/or selected by adding more LEDs and/or control signals, for example, blue (470 nm) or green (565 nm). No matter how many color(s) are used, however, the process of scanning may be consistent.

A combination of CPU 12, A/D converter 11, and amplifier 10 may control and/or receive data scanned from note 2 by linear array 5. Specifically, linear array 5 may be functionally connected to CPU 12 through signals STROBE and CLK. For example, in order to signal to linear array 5 to scan (e.g., capture light) note 2 and/or note channel 11, CPU 12 may set the STROBE function on high and send that signal to linear array 5. Linear array 5, being a scanner, may then turn “on” and begin to scan data reflected and/or transmitted from note 2 and/or note channel 11 from one or more of LEDs 7, 9. Once CPU 12 has determined that linear array 5 has been sufficiently exposed to note 2 and/or note channel 11, CPU 12 may set the STROBE function on low, and send the signal to linear array 5 to end scan. The timing between these STROBE signals may be used to control the amount of time linear array 5 is exposed to note 2 for each scan. Such exposure time may have been set and/or previously determined as necessary to provide sufficient light to linear array 5 from note 2 that can be converted into useful data.

For example in one illustrative embodiment using three LED colors, one exposure can be taken per 0.6 mm of length of note. This causes a slight overlap between pixels along the note so that there are no gaps between pixels. Using 3 colors, an exposure is taken in red, the note moves 0.2 mm during the exposure, then an exposure is taken in Blue, the note moves 0.2 mm during the exposure, then an exposure in IR, the note moves 0.2 mm, and the next exposure would be in Red again. More colors can be used if the exposure time is shortened such that a total time for all the colors is still less than the size of the pixel (such as 0.67 mm in the TSL1401R array) given the reduction factor used (about 10.5−11×). Accordingly, given a 150 mm long note 223 exposures per color (150/0.67) can occur.

Between the aforementioned settings of STROBE functions on high and low, linear array 5 may receive and convert light from note 2 and/or note channel 11 into analog data, and may hold that analog data in holding registers of linear array 5. CPU 12 may then clock CLK and send that signal to linear array 5. With each CLK signal, linear array 5 may send the data stored in holding registers to amplifier 10 as signal PIXELS. Signal PIXELS may be amplified and buffered by amplifier 10, and then sent to A/D converter 11. A/D converter 11 may sample the input, convert the analog signal into a digital representation of the input, and present the digital representation of signal PIXELS to CPU 12. CPU 12 may then store PIXELS in internal memory 16. This process may be repeated until all pixels of the array have been processed.

By controlling the STROBE and CLK signals, CPU 12 and/or linear array 5 may provide the capability of clocking out the electrical signal while capturing the next exposure, e.g., line of scanned data from a width of note 2, thus providing a continuous sampling and conversion process.

Currency validator 1 shown in FIGS. 1-2 is primarily configured to scan data (e.g., light) reflected from note 2. For example, light is transmitted from one or more of LEDs 7, 9 through transmission window 8, reflected off a surface of note 2 back through transmission window 8 onto lens 3, and then focused onto linear array 5 using lens 3.

Alternatively, a second set of independent LEDs (e.g., transmissive LEDs 102, 103 mounted on frame 101), mounted on a side of note transporter module 10 substantially opposite to linear array 5 and the first set of LEDS 7, 9, may be used to illuminate note 2. The light passing through note 2 from this second set of LEDs 102, 103 may be scanned by linear array 5 in substantially the same way that reflected light is scanned using the first set of LEDs (e.g., reflective LEDs 7, 9) mounted on the same side of note transporter module 10 as linear array 5. The second set of LEDs 102, 103 may be illuminated when the first set of LEDs 7, 9 are turned off, and the first set of LEDs 7, 9 may be turned on while the second set of LEDs 102, 103 are turned off.

Once the note has been scanned the processing unit now proceeds through the steps of recognizing and validating the note. When a note is verified, it is typically stored in a box or stacker that secures the note until the stacker is collected at a later time.

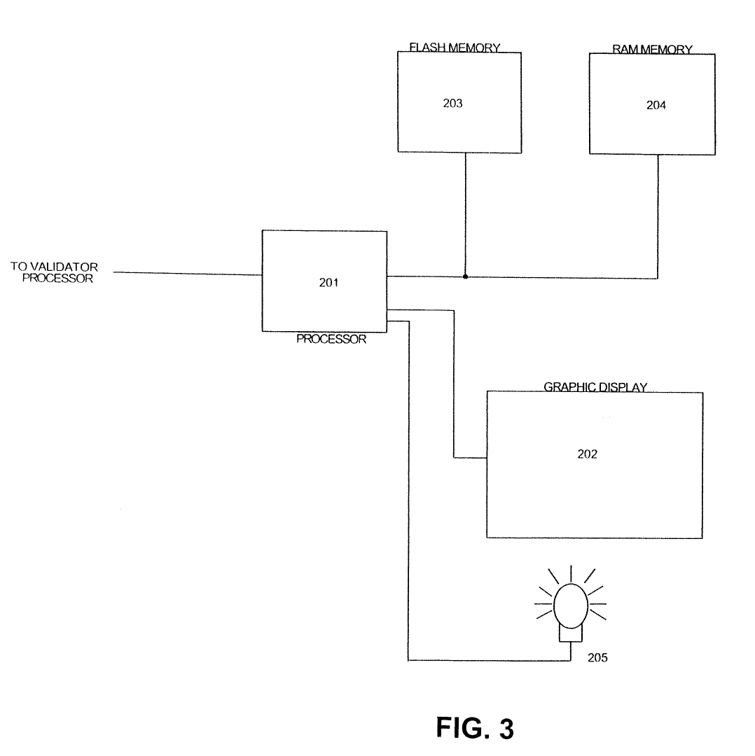

After the note has been stacked, either a portion of the note that clearly shows the denomination that has been accepted, or the entire face of the note can be displayed on a graphic display bezel. Referring to FIG. 3, the graphic display bezel consists primarily of four parts: processor 201, graphic display 202, flash memory 203, and ram memory 204. Processor 201 provides a communication link to the main validator processor, offloading the display requirements onto a separate device. Graphic display 202 is one of several types of pixel display units, such as a liquid crystal display (LCD) device (DMF-50081ZNB-FW) manufactured by Optrex America corporation. This display has a resolution of 320 pixels wide by 240 pixels high. Display 202 is embedded in the validator bezel and is typically illuminated by backlight 205. The display may also be a LED or an OLED display or any other type of display device known in the art.

The flash memory 203 can be used to store preset images that can be shown on graphic display 202. A sequence of pixels, divided into panes, can be pre-stored in the flash memory 203, for each of the standard operations the validator performs.

The RAM memory 204 can provide operating memory for processor 201 and allow custom images to be defined for display, as well as to provide temporary storage for diagnostic and statistical information.

In operation as an aesthetic mechanism, validator processor 12 would command processor 201 to turn on the display. The first pane of information is loaded from flash memory 203, and the processor manipulates display 202 to show the image. Backlight 205 is turned on by processor 201, illuminating display 202. After a preset amount of time, the next pane of information is loaded from memory 203, and processor 201 changes display 202 to show the next pane of information. This process continues, until the last pane in the sequence is displayed, at which time the processor will restart the sequence from the beginning or move onto another sequence of images.

Referring again to FIG. 3, we shall describe the operation of the bezel when a note has been accepted. Validator processor 12, having confirmed that note 2 has been deposited in the stacker, takes the image that was scanned of the note and selects one or more of the visible scanned planes of information. Typically, this would be one of the reflected planes of information since that would be the more ‘normal’ viewing condition of the note.

Depending on the size and resolution of display 202, the validator will select all or a portion of the scanned plane of the accepted note. For our example, we will assume that all of the plane can be displayed. Validator processor 12 will take the scanned plane image stored in data memory 16, and send this pixelated image to processor 201. Processor 201, takes the pixelated data and stores the information in Ram memory 204. After all of the data has been transferred, processor 201 then clears any image from display 202, and using the data in Ram memory, transfers the image to display 202. This image is left on display 202 until another note is inserted into the validator.

From a dispute resolution standpoint in a casino there is a significant advantage to using this type of device. If there is a dispute, rather than having to take the stacker out of the machine, a casino attendant can point to the graphic display to indicate the last bill inserted. The player will not have much room to dispute and thus make taking the stacker out of the machine unnecessary. This will save the casino both time and money.

In yet another application of the display, the graphic bezel can provide diagnostic information. Current technology using rows of LEDs, or the combined graphic and numeric bezels of previous devices (U.S. Pat. No. 6,712,191) are limited in their capabilities to display information to technical personnel when a problem occurs in a machine. The type of information that can be displayed is very basic.

As an example, a particular gaming machine may display a fixed pattern of lights when the stacker is full or jammed. Only technical personnel, trained to recognize the pattern, will be aware of a problem. Further, the technical personnel won't be able to gather much insight into the problem from the limited information displayed by such a system. The graphic display provides more clear and robust information since it can be programmed to display detailed data about a particular problem with the machine, rather than just a simple pattern.

In this instance, should the stacker become jammed, validator processor 12 would command the display processor 201, to display the stacker jammed image. In a typical application, this can be a picture of the stacker, along with the phrase “Stacker Jammed” on the display. Since the display is graphic, the text can be printed in one (or more) of the local languages, including such languages as Hebrew, Arabic, Russian etc, that do not use the 26 character alpha text used in the United States. Since in this design, the hardware is identical across all countries, no special molds or decal need be generated.

In another embodiment of the invention, the display bezel can include a separate diagnostic display that can be separate from the graphic display unit 202 so that the graphic display unit can continue to display images while a diagnostic message pops up on the diagnostic display. The diagnostic display can be made of the same material as the graphic display unit 202 and have the same resolution.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

1. A currency validator comprising:
a bill acceptor having a validator for determining the authenticity of a bill inserted into the acceptor;
a bezel assembly adjacent to an opening of the bill acceptor; and
a graphic display bezel mated to the bezel assembly, the graphic display bezel comprising:
a graphic display unit for displaying at least one portion of the bill, the at least one portion being selected based on a resolution and size of the graphic display unit, and
a random access memory that contains uploaded images representing notes that have been accented or rejected by the validator, the images being transferred to the graphic display unit using the random access memory.

2. The currency validator of claim 1, wherein the graphic display bezel further comprises:
a processor,
a semi-permanent memory store that contains pre-defined images representing standard operating modes of the currency validator,
an illumination device, and
a communication means to permit an external processor to command the operation of the display, including communicating said bill images to said random access memory.

3. The currency validator of claim 1, wherein the graphic display unit comprises a liquid crystal display (LCD).

4. The currency validator of claim 3, wherein the LCD is capable of displaying pixelated images.

5. The currency validator of claim 3, wherein the LCD is capable of displaying video.

6. A currency validator comprising:
a bill acceptor having a validator for determining the authenticity of a bill inserted into the acceptor;
a bezel assembly adjacent to an opening of the bill acceptor;
a graphic display bezel mated to the bezel assembly, the graphic display bezel comprising:
a graphic display unit for displaying at least one portion of the bill, the at least one portion being selected based on a resolution and size of the graphic display unit, and
a random access memory that contains uploaded images representing notes that have been accepted or rejected by the validator, the images being transferred to the graphic display unit using the random access memory; and
a diagnostic display panel.

7. The graphic display unit currency validator of claim 6, wherein the graphic display bezel comprises:
a processor,
a semi-permanent memory store that contains pre-defined images representing standard operating modes of the validator,
an illumination device, and
a communication means to permit an external processor to command the operation of the display, including communicating said bill images to said random access memory.

8. The currency validator of claim 6, wherein the graphic display unit comprises a liquid crystal display (LCD).

9. The currency validator of claim 8, wherein the LCD is capable of displaying pixelated images.

10. The currency validator of claim 8, wherein the LCD is capable of displaying video.

11. The currency validator of claim 6, wherein the diagnostic display panel comprises a graphic display unit such as a LCD.

12. The currency validator of claim 9, wherein the pixelated images comprises one of graphic displays, alphanumeric displays, or textual displays of operating characteristics of the currency validator.

13. The currency validator of claim 12, wherein textual displays are able to be displayed in multiple languages.
